(19) United States
(12) Patent Application Publication
(10) Pub. No.: US 2007/0000057 A1
(43) Pub. Date: Jan. 4, 2007

(54) Stretcher apparatus

(76) Inventor: Philip Ward, Settle (GB)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/474,603

(22) Filed: Jun. 26, 2006

(30) Foreign Application Priority Data
Jun. 29, 2005 (GB) 05 13221.2
Dec. 12, 2005 (GB) 05 25273.9

(51) Int. Cl. A61G 7/012; A61G 7/10; A61G 1/02

(52) U.S. Cl. 5/611; 5/86.1; 5/617; 296/20

(57) ABSTRACT

A trailing wheel assembly is moved such that its wheels 164 come into contact with the ground prior to loading the stretcher into an ambulance. Forward loading wheels 50 support the front of the stretcher on the ambulance floor 160. The undercarriage 12 is then raised and the stretcher is moved into the ambulance by the operator pushing, without the operator having to support any part of the stretcher. Just before the stretcher is fully home, the trailing wheel assembly 162 is moved into a storage position by pivoting the struts 166 and then pushing the struts into the rear of the stretcher to conceal the trailing wheel section between opposed side members of the upper frame of the stretcher.

The present invention relates to stretcher apparatus and to methods of loading and unloading stretchers from ambulances.

When loading and unloading ambulances into stretchers it is known to provide a roll in wheel on the upper frame that is rested on an ambulance floor. Then the undercarriage is raised and the trolley pushed in. Removal from the ambulance is a reversal of this procedure. In each case though the operative is required to support the rear of the stretcher. This can cause strain on the operative.

It is an object of the present invention to attempt to overcome at least one of the above or other problems.

The present invention is described in the claims appended hereto.

The present invention may include a patient support, a forward loading first wheel assembly arranged, in use, to provide support for the front of a stretcher during at least part of an ambulance loading or unloading procedure, at least one second wheel assembly arranged, in use, to provide support for the stretcher, the second wheel assembly being movable relative to the patient support whereby, in use, the second wheel assembly is arranged to be movable between a first position and a second position in which the second wheel assembly is closer to the patient support during at least part of a loading or unloading procedure, and a third wheel assembly arranged to provide support at a rear region of the stretcher.

The wheel arrangements may comprise wheel assemblies.

The stretcher may include struts that are each connected to the top and bottom frame of a stretcher. The struts may also be pivotally connected to each other at a location spaced from their connection to the top and bottom frames.

The stretcher may include control means or power means arranged to move the second wheel assembly from at least one of the first or second positions towards the other of those positions.

The third wheel arrangement may, in the first position, provide support at a rear region of the stretcher.

The present invention can be carried into practice in various ways but one embodiment will now be described by way of example and with reference to the accompanying drawings, in which:—

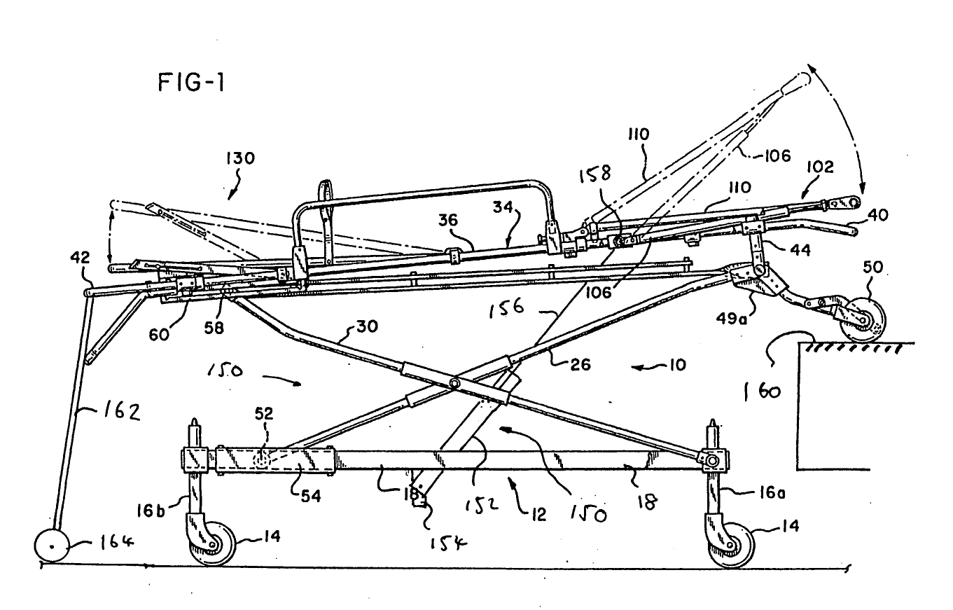

FIG. 1 is a side elevational view of the roll-in stretcher cot of the present invention with certain parts in broken lines for purposes of illustration;

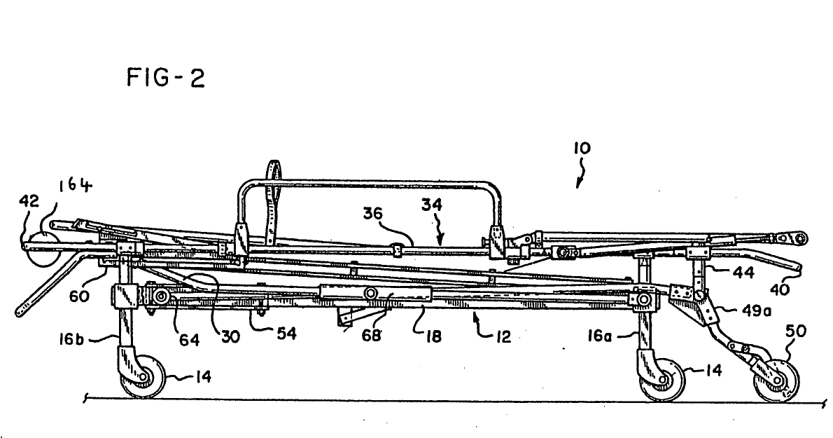

FIG. 2 is side elevational view of the stretcher of the present invention in a fully lowered configuration, with loading wheels on the ground;

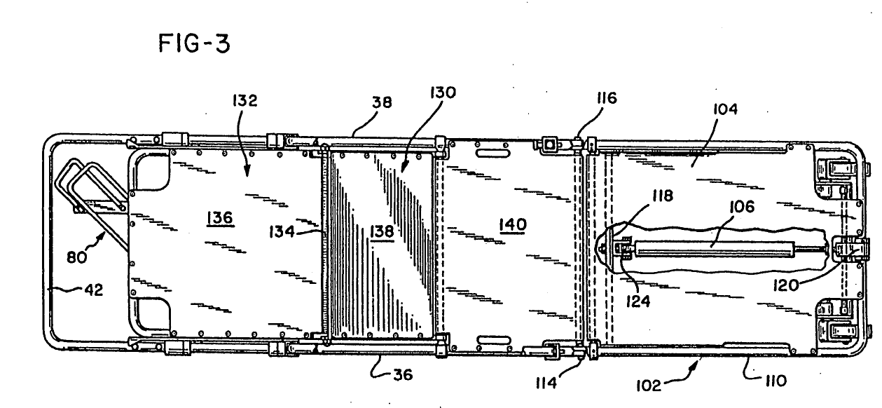

FIG. 3 is top plan view of the stretcher of FIG. 1, with certain parts broken away to show underlying parts;

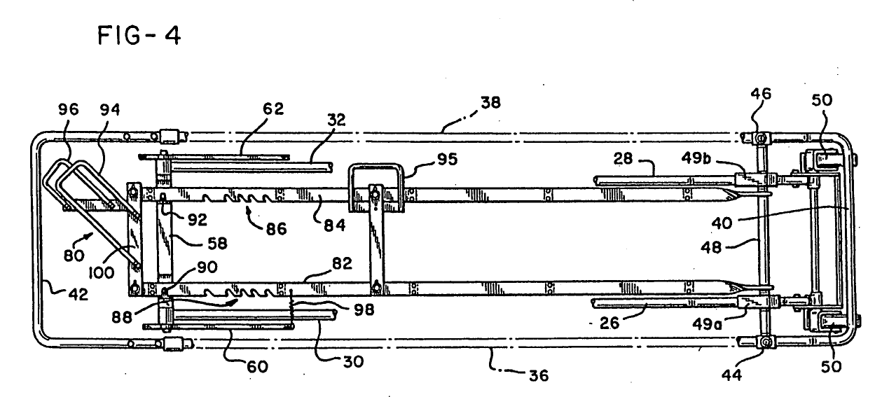

FIG. 4 is a top plan view of the latching mechanism of the stretcher, with certain parts removed for purposes of illustration;

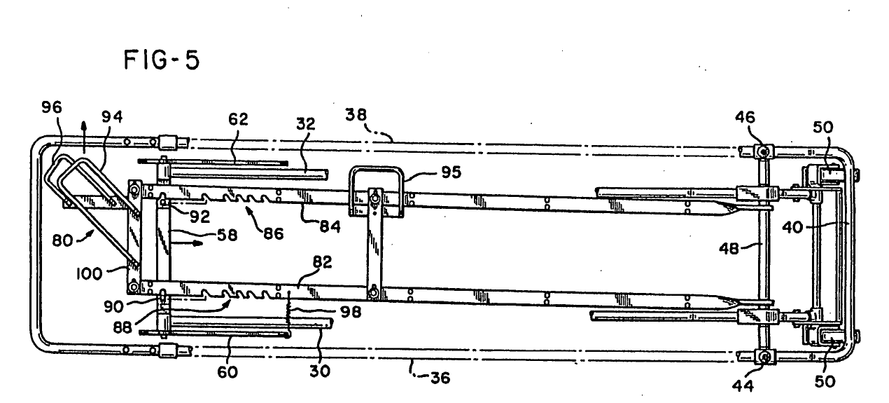

FIG. 5 is a top plan view of the latching mechanism of the stretcher showing the manner of releasing the mechanism, with certain parts removed for purposes of illustration;

FIG. 6 is a partial side plan view illustrating the back support mechanism;

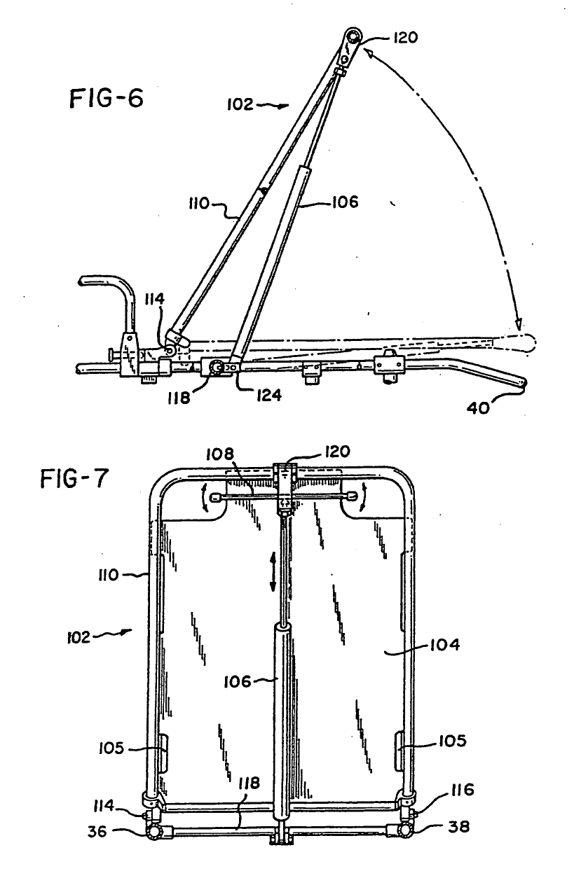

FIG. 7 is a partial end view illustrating the back support mechanism of the present invention;

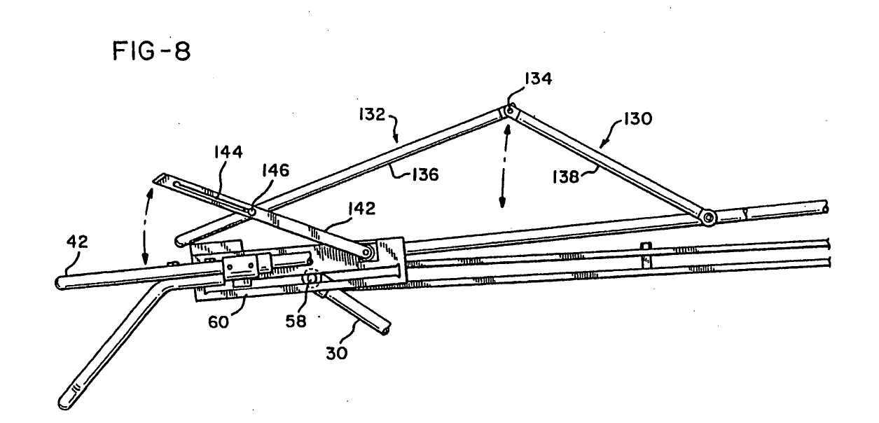

FIG. 8 is a partial side plan view illustrating an adjustable dual position foot support mechanism;

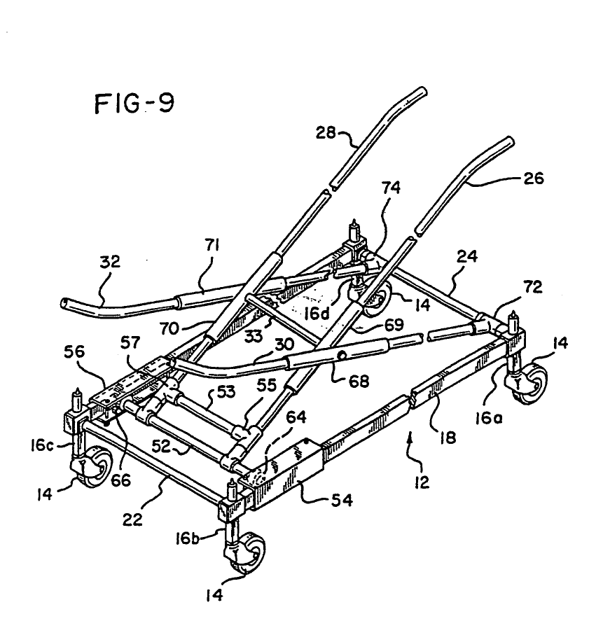

FIG. 9 is a perspective view of the undercarriage portion of the stretcher with the complementary cross-forming frame members;

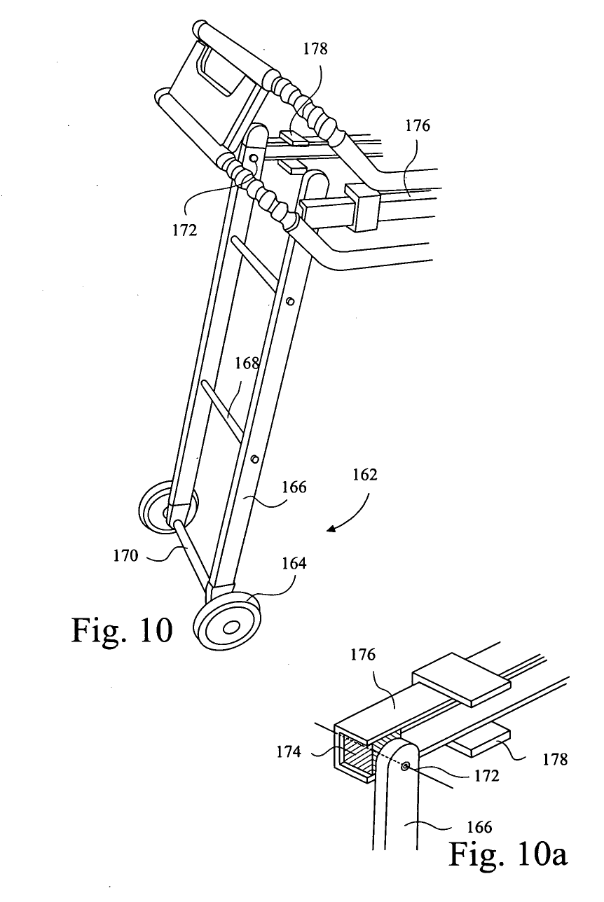

FIG. 10 is a perspective view showing a trailing wheel assembly 162 in a deployed position;

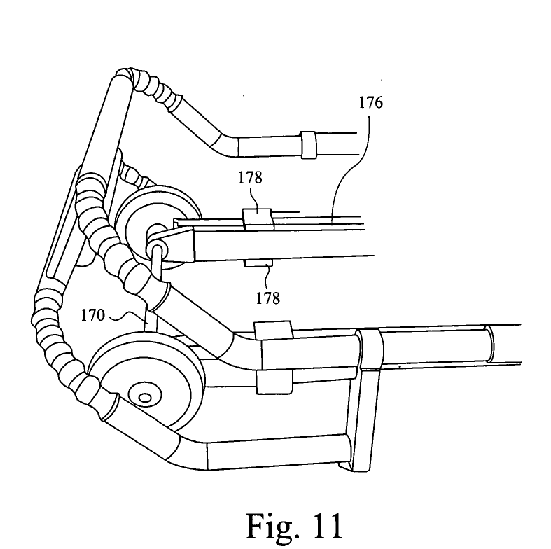

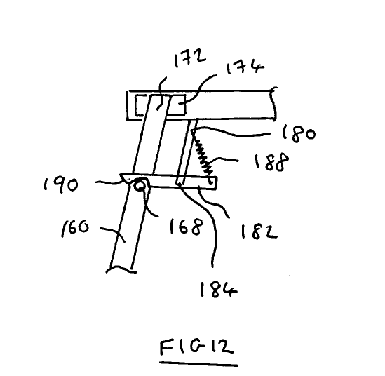

FIG. 11 is a perspective view showing the assembly 162 in a stored position, and

FIG. 12 is a schematic view showing a mechanism for retaining the assembly 162 in the deployed position.

Referring first to FIGS. 1, 2 and 9, the stretcher 10 of the present invention is illustrated in both an elevated (FIG. 1) and fully down (FIG. 2) position. The stretcher 10 has a rectangular undercarriage 12 including a pair of opposing side frame members 18, 20 interconnected by a pair of transverse frame members 22, 24. For purposes of explanation, the undercarriage will be referred to as having a leading or front end and a trailing end, with the leading end being defined as the end toward the loading wheels 50 on the cot frame 34. Undercarriage 12 also includes downwardly extending supports 16a, 16b, 16c and 16d affixed as shown at respective corners of the rectangular undercarriage. Undercarriage wheels 14 are attached to the downwardly extending supports in a conventional manner to provide high ground clearance for the undercarriage. This high clearance is particularly useful for ambulances having high wheel arches along their floors which the undercarriage of the stretcher must clear as it is rolled into the ambulance.

Referring also now to FIGS. 3 and 4, the stretcher frame 34 also has a leading or front end and a trailing end, with the leading end again being defined as the end toward the load wheels 50. The stretcher frame 34 includes a pair of opposing tubular side frame members 36, 38 which are interconnected at their respective ends by tubular transverse frame members 40, 42, respectively. The leading end of frame 34 includes a pair of supports 44, 46 which extend downwardly from each of opposing side frame members 36, 38. The opposite ends of supports 44, 46 are secured to a transverse member 48 (also seen in FIGS. 4 and 5) which extends across and below the frame 34. A pair of load wheels 50 are secured to frame 34 through transverse member 48 by rotatable fittings 49a and 49b.

As best viewed in FIG. 9, extending upwardly from undercarriage 12 are coacting pairs of complementary cross-forming frame members 26, 28, 30 32 extending between and interconnecting frame 34 and the undercarriage 12. The frame members in each respective pair are pivotally connected together intermediate their opposite ends by a transverse bar 33 and associated fittings and sleeves 68, 69, 70 and 71. The frame members 26, 28, 30 and 32 are operative to position stretcher 10 in at least a first “down” position and a second “up” position. The up position, in which the frame members and the cot frame are elevated, is shown in FIG. 1. In the down position, the frame members are fully collapsed as illustrated in FIG. 2. When in the fully collapsed position, undercarriage wheels 14 and the pair of load wheels 50 support the weight of stretcher 10. This permits the stretcher to be used for upright seating for several patients and passengers in an ambulance.

As shown, the first frame members of each pair 26, 28 are connected at their lowermost ends to opposite sides of a cross piece 52. Additional bracing and support is provided by a second cross piece 53 secured to frame members 26, 28 through fittings 55, 56. Opposing ends of cross piece 52 include rotatable rubber bearings 64, 66 which are slidably mounted in brackets 54, 56. Brackets 54, 56 are secured to opposing side frame members 18, 20 of undercarriage 12 adjacent the trailing end of undercarriage 12. The second frame members of each pair 30, 32 are rotatably connected at their lowermost ends to transverse frame member 24 on the leading end of undercarriage 12. As shown, the rotatable connections include T-shaped fittings 72, 74.

As best seen in FIGS. 1 and 4, the uppermost ends of first frame members 26, 28 are rotatably connected to transverse frame member 48 on cot frame 34 adjacent the leading end thereof. The uppermost ends of the second frame members 30, 32 are rotatably connected to a transverse support member 58. Transverse support member 58 is slidably mounted in a pair of opposing brackets 60, 62 secured to stretcher frame 34.

Referring now to FIGS. 4 and 5, the stretcher 10 includes means for latching the pairs of frame members 26, 28, 30 and 32 in said at least two, and preferably several positions ranging from a first down, fully collapsed position to a fully elevated position. The latching means are generally indicted at 80 and comprise a pair of latching bars 82, 84 secured together by cross piece 100. Each of the latching bars are secured at respective first ends thereof to transverse member 48 on frame 34 and at respective second ends thereof to cross piece 100. Each of the latching bars 82, 84 includes a plurality of spaced apart slots, generally indicated at 86, 88. The slots are angled and adapted to engage a corresponding pair of load-bearing 90, 92 located on transverse support member 58.

As shown, pin engaging means, such as handles 94 and 96, are operatively connected to the latching bars by a cross piece 100. These handles may be manipulated by the emergency medical technician standing at the end of the stretcher by pulling them in the direction indicated by the arrow in FIG. 5 to disengage pins 90, 92 from individual slots. An additional handle 95 is provided on latching bar 84 so that the latching mechanism may also be operated from one side of stretcher 10.

Spring 98 biases latching bars 82, 84 to force slots 86, 88 to engage with pins 90, 92. The technician may select the position in which cot 10 is placed, from fully down to fully elevated by sliding the latching mechanism in the direction of the arrow in FIG. 5 and then releasing the handle(s) to reengage the slots with pins 90, 92. As slots 86, 88 are angled to seat with pins 90, 92, and transverse support member 58 is load bearing, the latching mechanism provides a positive lock of stretcher 10 into a desired position.

Alternatively or additionally the upper stretcher frame 34 can be moved relative to the undercarriage 12 by means of an hydraulic or pneumatic or other expandable member 150. The hydraulic cylinder 152 of the expandable member is pivotally connected to the middle of a frame 154 that extends downwardly from the undercarriage 12. The piston 156 of the cylinder is connected in a cross member 158 of the upper frame. Expansion of the piston from the cylinder moves the upper frame 34 to the position shown in FIG. 2 and contraction moves the upper frame to rest on the lower frame. The piston can also hold the upper frame at distances between those extremes.

The stretcher frame 34 also includes longitudinally extending foot, seat, and back support sections which may be positioned to provide support and comfort to a patient during transport. Referring now to FIGS. 1,3,6 and 7, back support section 102 includes a flat support plate 104 which is secured to continuous tubular member 110 by suitable means such as rivets or screws. Plate 104 includes several cut-out areas, such as those indicated at 105, to permit hand holds to be obtained on continuous tubular member 110 as needed. Back support section 102 also includes a gas-assisted cylinder 106 for raising the back support section from a first substantially horizontal position as shown in FIGS. 1 and 6 to a plurality of raised positions, such as the raised positions shown in FIG. 6 and in dotted lines in FIG. 1. Manipulation of bar 108 by the emergency technician in any of the directions shown by the arrows in FIG. 7 causes a raising or lowering of the back support as desired. That is, depressing or raising either end of bar 18 by a technician depresses a detent on cylinder 106 which released a locking mechanism internally in the cylinder and permits movement of back support section 102. When bar 108 is released, it moves back to a centered, at rest, position permitting the detent on cylinder 106 to raise and locking back support section 102 in place.

As shown, back support section 102 is pivotally connected to the side frame members 36, 38 of cot frame 34 by bifurcated hinges 114 and 16. The hinges are of a conventional construction in which a bifurcated part receives a tongue part, the parts being connected together by a pivot pin. The hinges 114 and 116 are oriented to permit back rest section 102 to be moved from and to the positions indicated in the drawing figures. Also as shown, cylinder 104 is rotatably secured to a transverse member 118 on cot frame 34 via hinge 124. At its opposite end, cylinder 106 is secured to continuous tubular member 110 via a hinged mounting 120 which swivels to accommodate the raising and lowering of back support section 102.

Referring principally now to FIGS. 1, 3 and 8, the stretcher also includes an adjustable foot support section 130. Foot support section 130 includes first and second portions 130 and 132, respectively, which are pivotally connected along hinge 134. Those portions include flat plates 136, 138 for supporting a patient's legs. Together with seat plate 140, a complete patient support structure is provided.

As shown, pivotally mounted arms 142 (corresponding structure on opposite side of stretcher not shown) have guide slots 14 which receives a pin 146 is moveable to two different positions as desired. The guide slots include enlarged openings at both ends of the slots which latch the pins in place. In a first elevated position, shown in dotted lines in FIG. 1, pin 146 is locked in the end of guide slot 144 closest to the trailing end of cot 10. This causes both portions 136 and 138 to be raised to lift a patient's legs to a “shock” position as is known in the art.

The stretcher also shows a way of supporting the knees and legs in a bent position. To achieve this the pin 146 may be caused to travel along the length of guide slot 144 to a position at the opposite end of the slot. Lifting of arm 142 when the pin is locked in this position causes the first and second portions 136 and 138 to form an inverted-v position which supports a patient's knees and legs in a bent position.

The stretcher is loaded into an ambulance by adjusting the height of the loading wheels 50 to the height of an ambulance floor 160 seen in FIG. 1. Traditionally an operative has then held the rear of the stretcher and activated a button to cause the hydraulic, electro hydraulic or manually moveable undercarriage to come up to the upper frame. Then the operative pushes the stretcher into the ambulance with first the front and then the rear wheels 14 riding onto the ambulance floor 160 whilst the operative supports the weight at the rear of the stretcher.

With the present invention there is no need for those operatives to support the rear of the stretcher. Instead the operative adjusts the height of the stretchers to that shown in FIG. 1 either with loading wheels 50 being over the ambulance floor 160 or before the wheels are moved to that position. Then a trailing wheel assembly 162 is moved to and retained in an operative position. Then the undercarriage is raised and the stretcher moved into the ambulance until all wheels 14 are over the ambulance floor with the wheels 164 of the trailing assembly supporting the rear of the stretcher. Then the wheel assembly is retracted before the final push home into the ambulance. In this way the operative need not support the stretcher in any way at all. Removal from the ambulance is a reverse of this procedure.

Whilst FIG. 1 shows the stretcher being at an angle to the horizontal the stretcher may be horizontal, if desired.

FIG. 10 is a schematic perspective view of the rear of the stretcher showing the trailing wheel assembly 162 in an operative position. The assembly 162 comprises a pair of parallel struts 166 connected together by spaced rods 168. At their lower end an axle 170 extends across and supports the wheels 164. The upper end of each strut 166 includes a pivot connection 172 to a block 174.

To retract the assembly the struts 166 are raised to be in line with the axle of the upper frame by moving about the pivots 172. Then struts are pushed towards the front of the trolley with the block sliding in U-shaped channels 176 at each side until the position shown in FIG. 11 is arrived at. Inwardly projecting supports 178 at the end region of the channels retain the struts in line with the stretcher. It will be appreciated that the stretcher shown in FIG. 2 will need modifying slightly in order to effect the storage of the wheels to the position shown in that figure. When withdrawing and deploying the rear wheel assembly the struts are caused to remain in line with the stretcher until the struts and the blocks have passed the supports 178 at which time the assembly may be pivoted downwardly.

The length of the rear assembly 162 may be adjustable and may for instance be set up for the type of ambulances that it is to be used for. Adjustment may take place by the struts 166 being telescopically adjustable and with means for holding the telescopically adjusted position in place. It will be appreciated though that the wheels of the rear wheel assembly need not necessarily contact the ground when the assembly is first deployed: during loading the wheels 164, if not already in contact with the ground, will soon come into contact when the undercarriage is raised: during unloading the wheels 164 will come into contact with the ground, if not already in contact, by a slight tilting of the stretcher occurring when the centre of gravity moves beyond a certain point which may well be when the front wheels 14 come off the ambulance floor.

Although not shown, it is envisaged that the employment and deployment of the trailing wheel assembly 162 could be effected by power means such as a battery. These power means can alternatively or additionally also power the hydraulic cylinder that raises and lowers the undercarriage. Either or both of the hydraulic cylinder or the assembly 162 can be moved from at least one position to another by manually operable means such as a pump which may be a foot pump.

FIG. 12 is a schematic side view showing one means for retaining the trailing wheel assembly 162 in the deployed position. A U-shaped support 180 is connected to and depends down from each channel 176. A lever 182 is mounted about a pivot 184 on the support 180 and is biased against a block 186 on the support by a spring 188. When the trailing assembly is pivoted into the deployed position the strut 168 is brought against the inclined surface 190 of the lever 182 to bias the lever upwardly, against the action of the spring 188 until a notch on the lever snaps over the strut to hold the strut in place. To release the lever an operative raises the lever to allow the assembly 162 to be pivoted.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. Stretcher apparatus including a patient support and a first, forward wheel arrangement arranged, in use, to provide support for the front of a stretcher during at least part of an ambulance loading or unloading procedure, at least one second wheel assembly arranged, in use, to provide support for the stretcher, the second wheel assembly being movable relative to the patient support whereby, in use, the second wheel arrangement is arranged to be movable between a first position and a second position in which the second wheel assembly is closer to the patient support, the second wheel arrangement including first and second sub arrangements comprising wheeled supports spaced from each other in the fore and aft direction, the stretcher being transportable solely on the second wheel arrangement when the second wheel arrangement is in the first position, the stretcher including a third wheel arrangement spaced from the first wheel arrangement in the fore and aft direction of the stretcher apparatus and movable from a second position to a first position in which, in the first position, the third wheel arrangement is arranged to support part of the stretcher apparatus during at least part of an ambulance loading or unloading procedure.

2. Apparatus as claimed in claim 1 in which the third wheel arrangement is arranged, when in the first position, to provide support for the apparatus during at least part of an ambulance loading or unloading procedure at a location rearward of both of the sub assemblies of the second wheel arrangement.

3. Apparatus as claimed in claim 1 in which the third wheel arrangement is arranged to support at least part of the stretcher on the ground during at least part of the time that the stretcher is loaded or unloaded from an ambulance.

4. Apparatus as claimed in claim 1 in which the third wheel arrangement, when in the second position, is arranged to maintain the elevation of the patient support at the same elevation as the support had prior to moving the second arrangement from the first to the second position.

5. Apparatus as claimed in claim 1 in which, in the second position of the third wheel arrangement, the third wheel arrangement is located in the region of the patient support.

6. Apparatus as claimed in claim 1 in which the third wheel arrangement in the second position is located wholly beneath the patient support.

7. Apparatus as claimed in claim 1 in which the third wheel arrangement in the second position is supported by a frame of the patient support.

8. Apparatus as claimed in claim 7 in which the third arrangement in the second position is supported by guides provided by the frame.

9. Apparatus as claimed in claim 7 in which the third wheel arrangement in the second position extends between opposed members of the frame of the patient support.

10. Apparatus as claimed in claim 1 in which the third wheel arrangement is pivotally mounted on the apparatus whereby pivotal movement is arranged to occur during at least part of the movement between the first, deployed position and the second position.

11. Apparatus as claimed in claim 1 in which the third arrangement is slidably mounted on the apparatus whereby sliding movement is arranged to occur during at least part of the movement from the first to the second position.

12. Apparatus as claimed in claim 10 in which the third arrangement includes a slidably mounted member to which a pivotally mounted member of the arrangement is connected.

13. Apparatus as claimed in claim 1 in which the extent of the third wheel arrangement from the patient support is adjustable whereby the third wheel arrangement can support the rear region of the stretcher at different heights.

14. Apparatus as claimed in claim 13 in which the third wheel arrangement includes a telescopically mounted portion.

15. Apparatus as claimed in claim 13 in which the angle of the third wheel arrangement to the patient support remains constant regardless of the extent.

16. Apparatus as claimed in claim 1 whereby power means are arranged, in use, to drive the third wheel arrangement from at least one of the first or second positions to the other of those positions.

17. Apparatus as claimed in claim 1 including releasable retaining means arranged to retain the third arrangement in the first position.

18. Apparatus as claimed in claim 17 in which movement of the third arrangement to the first position is arranged to cause the retaining means to automatically retain the third arrangement in the first position.

19. Apparatus as claimed in claim 1 in which the sub assemblies of the second wheel assembly are connected together such that they are constrained to move together when moving between the first and second positions.

20. Apparatus as claimed in claim 19 in which the sub assemblies are connected together by a linkage that constrains the assemblies to move together between the first and second positions.

21. A method of loading a stretcher including a patient support into an ambulance comprising locating loading wheels at a front region of a patient support over an ambulance floor, moving a second wheel arrangement including first and second sub arrangements comprising wheeled supports spaced from each other in the fore and aft direction from a first position to a second position closer to the patient support and pushing the stretcher into the ambulance with a third wheel arrangement at a rear region of the stretcher providing support for at least part of the movement into the ambulance.

22. A method as claimed in claim 21 in which the third wheel assembly supports the stretcher on the ground during at least part of the movement of the stretcher into the ambulance.

23. A method as claimed in claim 22 in which movement of the second wheel arrangement from the first portion is arranged to bring the third wheel arrangement into engagement with the ground.

24. A method as claimed in claim 21 in which the method comprises first supporting the stretcher only with the second wheel assembly, and subsequently supporting the stretcher only with the loading wheels and the third wheel arrangement during advancement and loading of the stretcher into an ambulance.

25. A method as claimed in claim 21 in which movement of the second wheel arrangement from the first position causes the loading wheels to be brought into contact with an ambulance floor.

26. A method as claimed in claim 21 in which movement of the second wheel arrangement from the first position causes the third wheel arrangement to provide support for at least the rear region of the stretcher.

27. A method as claimed in claim 21 comprising the second wheel arrangement providing support for the stretcher as the stretcher is moved into the ambulance for at least part of that movement.

28. A method as claimed in claim 21 comprising moving the third wheel arrangement from the position where that arrangement provides support for the stretcher after movement of the stretcher into the ambulance has commenced.

29. A method as claimed in claim 28 comprising moving the third wheel assembly from the position in which it provides support when the second wheel assembly is able to provide support for the stretcher.

30. A method of unloading a stretcher including a patient support from an ambulance comprising partially withdrawing a stretcher from the ambulance and supporting a rear region of the stretcher on the ground with a third wheel arrangement, continuing to withdraw the stretcher and moving a second wheel arrangement including first and second sub arrangements comprising wheeled supports spaced from each other in the fore and aft direction from a second position to a first position in which the second wheel arrangement is further from a patient support and continuing to withdraw the stretcher from the ambulance and supporting the front region of the stretcher with a first wheel arrangement during at least part of the unloading.

31. A method as claimed in claim 30 comprising first supporting the stretcher with at least one of the first and second wheel arrangements subsequently supporting at least the rear of the stretcher with the third wheel arrangement and the first wheel arrangement and then supporting the stretcher only with the second wheel arrangement.
